(19) United States
(12) Patent Application Publication
(10) Pub. No.: US 2021/0173880 A1
(43) Pub. Date: Jun. 10, 2021

(54) ASTROLOGICAL SOCIAL MEDIA INTERFACE

(71) Applicant: Snap Inc., Santa Monica, CA (US)

(72) Inventors: Andrew Grosvenor Cooper, Los Angeles, CA (US); Eunice Kim, Los Angeles, CA (US); Denise Marcela Martinez, Los Angeles, CA (US); Charles Melbye, Los Angeles, CA (US); Sana Park, Santa Monica, CA (US); Jeremy Voss, Los Angeles, CA (US)

(21) Appl. No.: 16/703,577

(22) Filed: Dec. 4, 2019

(51) Int. Cl. G06F 16/954; G06F 16/951; G06F 16/957; G06F 16/9538; G06F 16/9535

(52) U.S. Cl. CPC G06F 16/954; G06F 16/951; G06F 16/9535; G06F 16/9538; G06F 16/9577

(57) ABSTRACT

An astrological interface system to access first user profile data of a first user, the first user profile data including a birthdate, assign a first astrological sign from among a plurality of astrological signs to the first user based on the birthdate, the first astrological sign corresponding with a first set of attributes, access second user profile data of a second user, the second user profile associated with a second astrological sign from among the plurality of astrological signs, the second astrological sign corresponding with a second set of attributes, generate a compatibility index based on the first set of attributes and the second set of attributes, the compatibility index comprising a plurality of compatibility categories that include corresponding scores, and generate a visualization of the compatibility index, the visualization of the compatibility index based on the first astrological sign and the second astrological sign.

### TECHNICAL FIELD

Embodiments of the present disclosure relate generally to mobile computing technology and, more particularly, but not by way of limitation, to systems for generating and presenting astrological social media content at a plurality of client devices.

### BACKGROUND

Astrology is a pseudoscience that claims to divine information about relationships and terrestrial events by studying the movements and relative positions of celestial objects, and by referencing a horoscope that represents he positions of the Sun, Moon, planets, astrological aspects and sensitive angles over time. To create a horoscope, an astrologer first has to ascertain the exact time and place of the subject's birth, or the initiation of an event. The local standard time (adjusting for any daylight-saving time or war time) is converted into Greenwich Mean Time or Universal Time at that same instant. The astrologer then converts this into the local sidereal time at birth in order to be able to calculate the ascendant and midheaven. The astrologer next consults a set of tables called an ephemeris, which lists the location of the Sun. Moon and planets for a particular year, date and sidereal time, with respect to the northern hemisphere vernal equinox or the fixed stars (depending on which astrological system is being used). The astrologer then adds or subtracts the difference between the longitude of Greenwich and the longitude of the place in question to determine the true local mean time (LMT) at the place of birth to show where planets would be visible above the horizon at the precise time and place in question.

In an unrelated field, social networking services are online platforms which people use to build social networks or relationships with other people who share similar interests, activities, backgrounds, or other connections. Social networking sites allow users to share ideas, digital photos and videos, posts, and to inform others about online or real-world activities and events with people in their network.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example messaging system for exchanging data (e.g., messages and associated content) over a network in accordance with some embodiments, wherein the messaging system includes a dynamic menu system.

FIG. 2 is block diagram illustrating further details regarding a messaging system, according to example embodiments.

FIG. 3 is a block diagram illustrating various modules of an astrological interface system, according to certain example embodiments.

FIG. 4 is a flowchart depicting a method of generating and causing display of a compatibility index, according to certain example embodiments.

FIG. 5 is a flowchart depicting a method of identifying a user from among a list of user connections, according to certain example embodiments.

FIG. 6 is a flowchart depicting a method of causing display of a visualization of a compatibility index, according to certain example embodiments.

FIG. 7 is a flowchart depicting a method of generating a visualization of a compatibility index, according to certain example embodiments.

FIG. 8 is an interface diagram depicting a GUI generated and displayed by an astrological interface system, according to certain example embodiments.

FIG. 9 is an interface diagram depicting a GUI generated and displayed by an astrological interface system, according to certain example embodiments.

FIG. 10 is an interface diagram depicting a presentation of a compatibility index generated by an astrological interface system, according to certain example embodiments.

FIG. 11 is an interface diagram depicting a GUI generated and displayed by an astrological interface system, according to certain example embodiments.

FIG. 12 is a block diagram illustrating a representative software architecture, which may be used in conjunction with various hardware architectures herein described and used to implement various embodiments.

FIG. 13 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

According to certain example embodiments, an astrological interface system may be configured to perform operations that include: accessing first user profile data of a first user, the first user profile data including a birthdate; assigning a first astrological sign from among a plurality of astrological signs to the first user based on the birthdate, the first astrological sign corresponding with a first set of attributes; accessing second user profile data of a second user, the second user profile associated with a second astrological sign from among the plurality of astrological signs, the second astrological sign corresponding with a second set of attributes; generating a compatibility index based on the first set of attributes and the second set of attributes, the compatibility index comprising a plurality of compatibility categories that include corresponding scores; generating a visualization of the compatibility index, the visualization of the compatibility index based on the first astrological sign and the second astrological sign; and causing display of a presentation of the visualization at a client device.

In some embodiments, the second user profile may be associated with the first user profile as a social network connection in a contacts or friends list of the first users. Accordingly, the astrological interface system may access a list of social network connections of the first user to identify one or more user profiles based on the first set of attributes of the first astrological sign of the first user. For example, the astrological interface system may rank the list of social network connections based on corresponding attributes and compatibility indices. In such embodiments, the astrological interface system may present to the first user a list of the most “similar” users from their social network connections based on the ranking.

In some embodiments, the second user profile may be associated with a client device located within a threshold distance of a first client device associated with the first user. For example, in some example embodiments, the astrological interface system may identify a plurality of client devices proximate to a location of a client device associated with the first user profile. The proximity may be based on a threshold distance from a location of the client device (i.e., a radius extending a threshold distance), or in some embodiments may be based on co-location of the plurality of client devices within a geo-fenced area occupied by the client device associated with the first user profile.

In some embodiments, the astrological interface system may identify user devices associated with user profiles that have opted into a predefined feature or application or have populated one or more fields of a user profile (i.e., astrological information). In such embodiments, only those user profiles that have opted in or have provided the necessary user profile information may be identified by the astrological interface system for the purposes of generating and presenting a compatibility index.

In some embodiments, the astrological interface system may display the presentation of the visualization of the compatibility index, or other media content, responsive to determining that one or more scores of the compatibility index transgress a threshold value. In such embodiments, the media contented presented may also be determined based on how many of the one or more compatibility index scores transgresses corresponding threshold values, as well as a degree of the transgression (i.e., the value of a difference between scores of corresponding categories). As an illustrative example, assuming there are ten scored compatibility index categories, wherein each category is scored on a 1-10 basis, each compatibility category may have a corresponding threshold value. For example, “Category 1” may have a threshold score of 5, while “Category 2” has a threshold score of 9.

In some example embodiments, the visualization of the compatibility index may comprise a display of scores associated with a set of compatibility categories, wherein the display of the scores may be represented as a bar, wherein the score is represented as a portion of the bar. Accordingly, in some embodiments, the astrological interface system may be configured to receive an input selecting a score indicator of a compatibility category, and in response, may present additional media or content related to the selected compatibility category.

In some embodiments, responsive to determining that one or more of the compatibility index scores transgresses a threshold value, the astrological interface system may generate and cause display of a notification at one or more client devices, including at least the first client device and second client device. In such embodiments, the notification may include the presentation of the visualization of the compatibility index.

Consider an illustrative example from a user perspective. A first user may provide the astrological interface system with inputs defining user attributes and user data, including date of birth, place of birth, and time of birth. The astrological interface system may then assign the user profile with one or more astrological signs based on the provided user data.

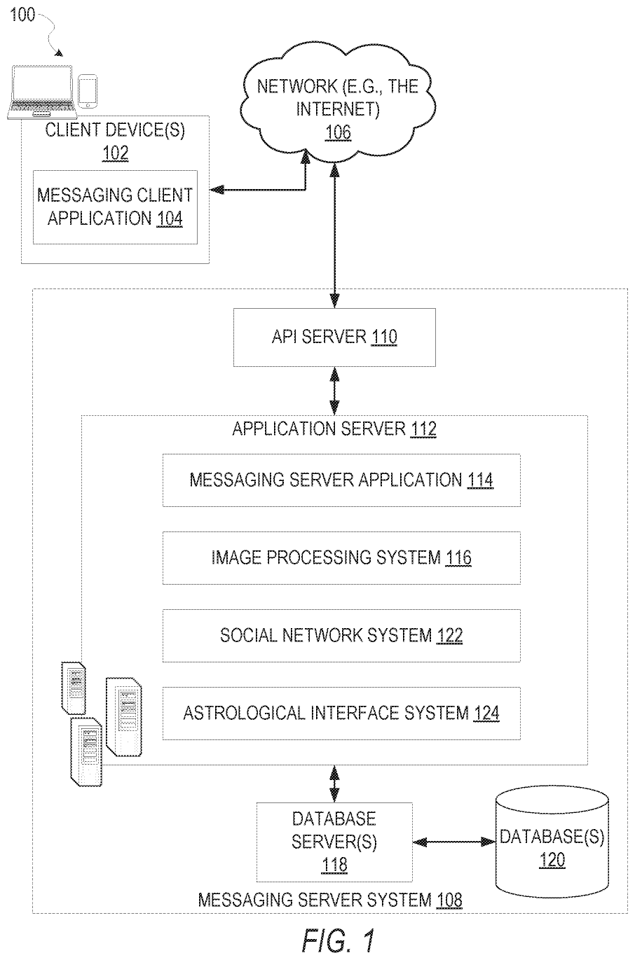

FIG. 1 is a block diagram showing an example messaging system 100 for exchanging data (e.g., messages and associated content) over a network. The messaging system 100 includes one or more client device 102 which host a number of applications including a messaging client application 104. Each messaging client application 104 is communicatively coupled to other instances of the messaging client application 104 and a messaging server system 108 via a network 106 (e.g., the Internet).

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. In some embodiments, this data includes, message content, client device information, geolocation information, media annotation and overlays, message content persistence conditions, social network information, and live event information, as examples. In other embodiments, other data is used. Data exchanges within the messaging system 100 are invoked and controlled through functions available via GUIs of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of media files (e.g., images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

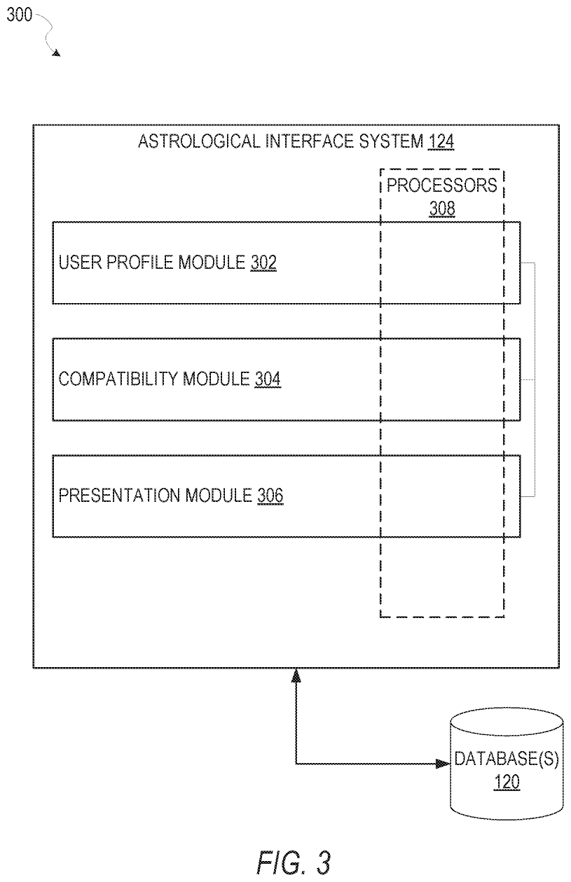

The application server 112 hosts a number of applications and subsystems, including a messaging server application 114, an image processing system 116, a social network system 122, and an astrological interface system 124. The astrological interface system 124 is configured to generate and present a compatibility index based on one or more attributes associated with a plurality of user accounts. Further details of the astrological interface system 124 can be found in FIG. 3 below.

The messaging server application 114 implements a number of message processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received within the payload of a message at the messaging server application 114.

The social network system 122 supports various social networking functions services, and makes these functions and services available to the messaging server application 114. To this end, the social network system 122 maintains and accesses an entity graph 304 within the database 120. Examples of functions and services supported by the social network system 122 include the identification of other users of the messaging system 100 with which a particular user has relationships or is “following,” and also the identification of other entities and interests of a particular user.

The application server 112 is communicatively coupled to a database server 118, which facilitates access to a database 120 in which is stored data associated with messages processed by the messaging server application 114.

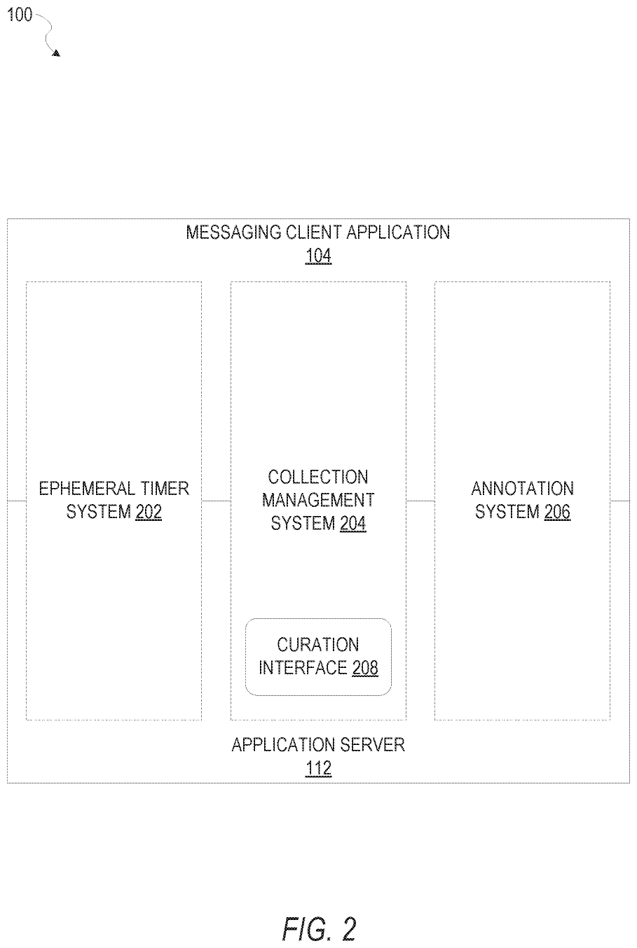

FIG. 2 is block diagram illustrating further details regarding the messaging system 100, according to example embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, collection of messages (e.g., a SNAPCHAT story), or graphical element, selectively display and enable access to messages and associated content via the messaging client application 104. Further details regarding the operation of the ephemeral tinier system 202 are provided below.

The collection management system 204 is responsible for managing collections of media (e.g., collections of text, image video and audio data). In some examples, a collection of content (e.g., messages, including images, video, text and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of media overlays for messages processed by the messaging system 100. The annotation system 206 operatively supplies a media overlay (e.g., a SNAPCHAT filter, lens) to the messaging client application 104 based on a geolocation of the client device 102. In another example, the annotation system 206 operatively supplies a media overlay to the messaging client application 104 based on other information, such as, social network information of the user of the client device 102. A media overlay may include audio and visual content and visual effects. Examples of audio and visual content include pictures, texts, logos, animations, and sound effects, as well as animated facial models. An example of a visual effect includes color overlaying. The audio and visual content or the visual effects can be applied to a media content item (e.g., a photo or video) at the client device 102. For example, the media overlay including text that can be overlaid on top of a photograph generated taken by the client device 102. In another example, the media overlay includes an identification of a location overlay (e.g., Venice beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular media overlay should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest bidding merchant with a corresponding geolocation for a predefined amount of time

FIG. 3 is a block diagram illustrating components of the astrological interface system 124 that configure the astrological interface system 124 to perform operations to generate and cause display of a presentation of a compatibility index at one or more client devices 102, according to certain example embodiments.

In further embodiments, the components of the astrological interface system 124 may configure the astrological interface system 124 to perform operations that include: accessing first user profile data of a first user, the first user profile data including a birthdate; assigning a first astrological sign from among a plurality of astrological signs to the first user based on the birthdate, the first astrological sign corresponding with a first set of attributes; accessing second user profile data of a second user, the second user profile associated with a second astrological sign from among the plurality of astrological signs, the second astrological sign corresponding with a second set of attributes; generating a compatibility index based on the first set of attributes and the second set of attributes, the compatibility index comprising a plurality of compatibility categories that include corresponding scores; generating a visualization of the compatibility index, the visualization of the compatibility index based on the first astrological sign and the second astrological sign; and causing display of a presentation of the visualization at a client device.

The astrological interface system 124 is shown as including a user profile module 302, a compatibility module 304, and a presentation module 306, all configured to communicate with each other (e.g., via a bus, shared memory, or a switch). Any one or more of these modules may be implemented using one or more processors 308 (e.g., by configuring such one or more processors to perform functions described for that module) and hence may include one or more of the processors 308. In certain embodiments, the astrological interface system 124 may include or have access to the database 120, wherein the database 120 may comprise a collection of media content indexed based on user attributes and astrological signs.

Any one or more of the modules described may be implemented using hardware alone (e.g., one or more of the processors 308 of a machine) or a combination of hardware and software. For example, any module described of the astrological interface system 124 may physically include an arrangement of one or more of the processors 308 (e.g., a subset of or among the one or more processors of the machine) configured to perform the operations described herein for that module. As another example, any module of the astrological interface system 124 may include software, hardware, or both, that configure an arrangement of one or more processors 308 (e.g., among the one or more processors of the machine) to perform the operations described herein for that module. Accordingly, different modules of the astrological interface system 124 may include and configure different arrangements of such processors 308 or a single arrangement of such processors 308 at different points in time. Moreover, any two or more modules of the astrological interface system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

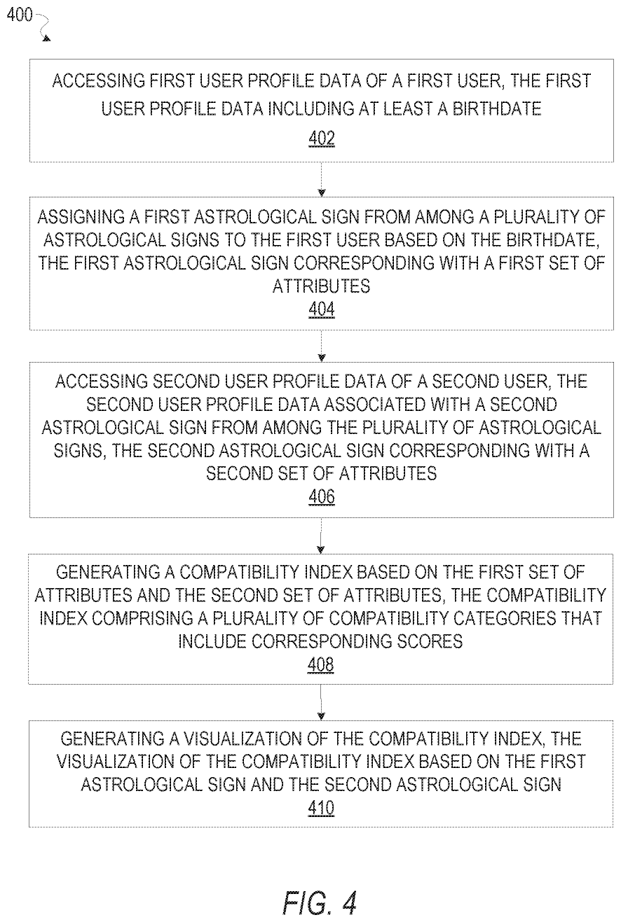

FIG. 4 is a flowchart depicting a method 400 of generating a visualization of a compatibility index, according to certain example embodiments. Operations of the method 400 may be performed by the modules described above with respect to FIG. 3. As shown in FIG. 4, the method 400 includes one or more operations 402, 404, 406, 408, and 410.

At operation 402, the user profile module 302 accesses first user profile data of a first user. The user profile data may include user demographics data, as well as personal information provided by the user, such as date of birth, place of birth (city, country, state, etc.), and time of birth. Based on the user profile data, the user profile module 302 may access one or more of the databases 120 in order to identify an astrological sign to be associated with the first user profile, as in operation 404.

According to certain example embodiments, the astrological sign (i.e., a first astrological sign) may include a corresponding set of attributes used to determine compatibility between users. For example, each attribute may be scored based on user profile data of the user, wherein the scores of the attributes may be used to match and rank compatibility with other users.

At operation 406, the user profile module 302 accesses second user profile data of a second user, wherein the second user profile data is associated with a second astrological sign from among the plurality of astrological signs and corresponds with a second set of attributes. In some embodiments, the second user may be identified among a plurality of user connections associated with the first user, or in further embodiments may be located within a threshold distance from the user or co-located within a shared geo-fence with the user.

At operation 408, the compatibility module 304 generates a compatibility index based on attributes associated with the astrological signs of the first user and the second user (i.e., the first set of attributes and the second set of attributes). In some embodiments, the compatibility index comprises a plurality of compatibility categories that each have corresponding scores, wherein the scores are based on the first set of attributes associated with the first astrological sign (of the first user), and the second set of attributes associated with the second astrological sign (of the second user). At operation 410, the presentation module 306 generates and causes display of a visualization of the compatibility index at one or more client devices 102. For example, in some embodiments the presentation module 306 may present a notification at a first client device associated with the first user and a second client device associated with the second user, wherein the notification includes a display of the visualization of the compatibility index.

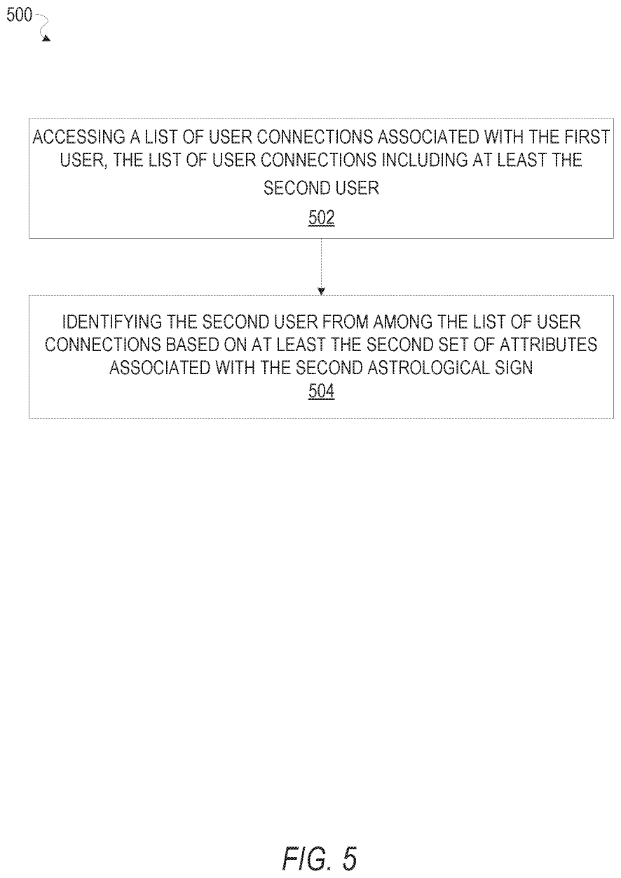

FIG. 5 is a flowchart depicting a method 500 of identifying a second user, according to certain example embodiments. Operations of the method 500 may be performed by the modules described above with respect to FIG. 3. In some embodiments, the method 500 may be performed as part of (i.e., a subroutine) operation 406 of the method 400. As shown in FIG. 5, the method 500 includes one or more operations 502 and 504.

At operation 502, the user profile module 302 accesses a list of user connections associated with the first user, wherein the list of user connections includes at least the second user. In some embodiments, the user connections may comprise a friends list curated by the first user (i.e., a buddy list). In some embodiments, the list of user connections may be based on geolocation criteria. For example, the list of user connections may be generated by the user profile module 302 based on a location of the first user, wherein the location may be determined based on geo-location coordinated retrieved from a client device 102 associated with the first user or based on a geo-fence in which the first user is located. For example, in some embodiments, the user profile module 302 may identify a plurality of users located within a threshold distance of the first user, based on location data retrieved from the client device 102 associated with the first user.

At operation 504, the user profile module 302 identifies the second user from among the list of user connections based on at least the second set of attributes associated with the second astrological sign of the second user. For example, the compatibility module 304 may rank the list of user connections based on corresponding astrological signs and attributes, and then identify one or more users that include the second user from among the list of user connections based on the ranking.

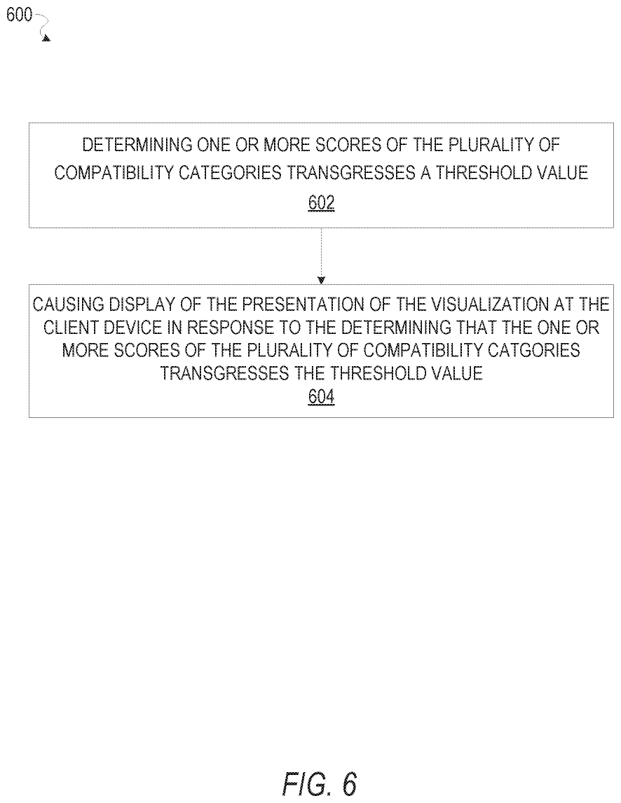

FIG. 6 is a flowchart depicting a method 600 of causing display of a visualization of a compatibility index, according to certain example embodiments. Operations of the method 600 may be performed by the modules described above with respect to FIG. 3. In some embodiments, the method 600 may be performed as part of (i.e., a subroutine) operation 410 of the method 400. As shown in FIG. 6, the method 600 includes one or more operations 602 and 604.

At operation 602, the compatibility module 304 determines that one or more scores of the plurality of compatibility categories transgresses a threshold value. According to certain embodiments, each compatibility category may have its own corresponding threshold value. The threshold value may comprise a plurality of threshold values. For example, the threshold value may comprise an upper threshold value as well as a lower threshold value for each compatibility category. Accordingly, transgressing the threshold value may include detection of values that are below a lower threshold value, or above an upper threshold value.

At operation 604, responsive to the compatibility module 304 determining that the one or more scores of the plurality of compatibility categories of the compatibility index of the first user and second user transgresses the threshold value, the presentation module 306 generates and causes display of a presentation of the visualization at a first client device 102 associated with the first user and a second client device 102 associated with the second user.

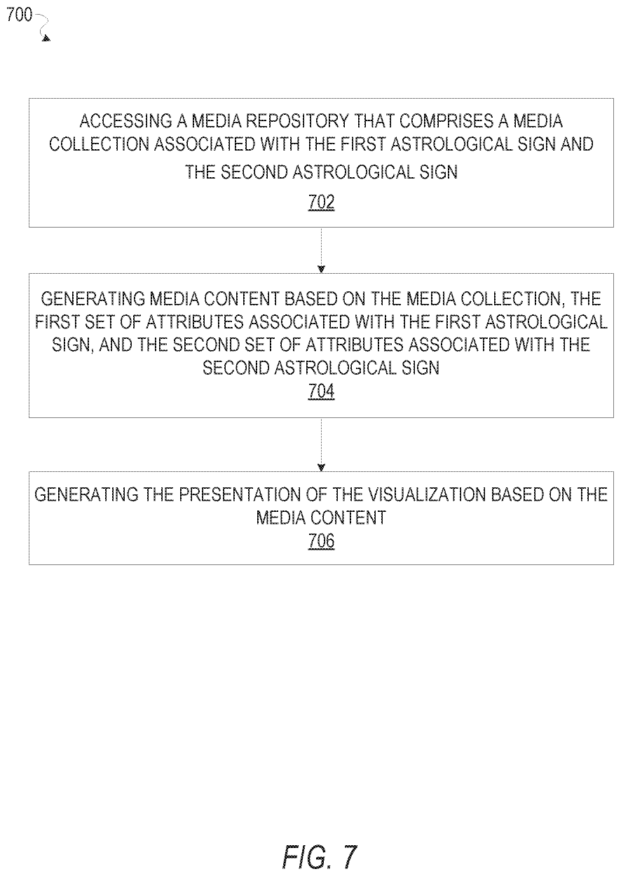

FIG. 7 is a flowchart depicting a method 700 of generating a visualization of a compatibility index, according to certain example embodiments. Operations of the method 700 may be performed by the modules described above with respect to FIG. 3. As shown in FIG. 7, the method 700 includes one or more operations 702, 704, and 706.

At operation 702, the presentation module 306 accesses media repositories based on the first astrological sign and the second astrological sign. For example, the databases 120 may comprise media content indexed in media collections based on astrological signs and attributes.

At operation 704, the presentation module 306 generates media content based on the media content from the media collections in the databases 120. For example, the presentation module 306 may retrieve media content associated with the first astrological sign and the second astrological sign and generate the media content to be presented in the visualization of the compatibility index based on the retrieved media content. The media content may include graphical content (i.e., pictures and videos), as well as audio content, and text-based content.

At operation 708, the presentation module 306 generates a presentation of the visualization of the compatibility index, wherein the presentation of the visualization includes the generated media content.

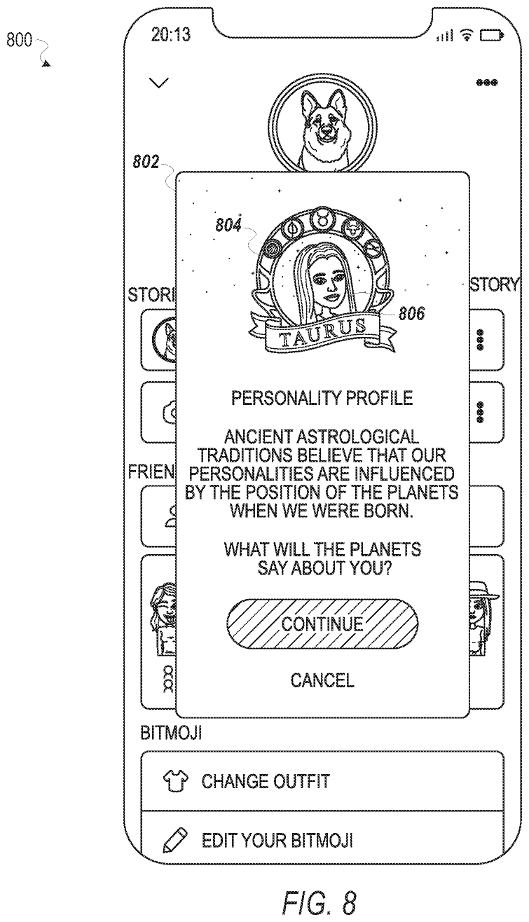

FIG. 8 is an interface diagram 800 depicting a GUI generated and displayed by the astrological interface system 124. As seen in FIG. 8, the GUI includes a display of a menu element 802, wherein the menu element 802 comprises a presentation of media content 804 generated based on user attributes of a user (i.e., an astrological sign assigned to a user account of the user based on the user's date of birth), and a user identifier 806 associated with the user.

As an illustrative example, a user may login to an application at the client device 102. Responsive to receiving the login, the astrological interface system 124 may determine that the user has not provided some or all of their user information. In response to determining that some of the user information is missing or has not been supplied by the user, the astrological interface system 124 may cause display of the menu element 802 as a request to gather more user information from the user. According to such embodiments, the astrological interface system 124 may generate the media content 804 based on an astrological sign assigned to the user, and a user's user identifie 06, wherein the user identifier 806 may be configured by the user based on one or more inputs.

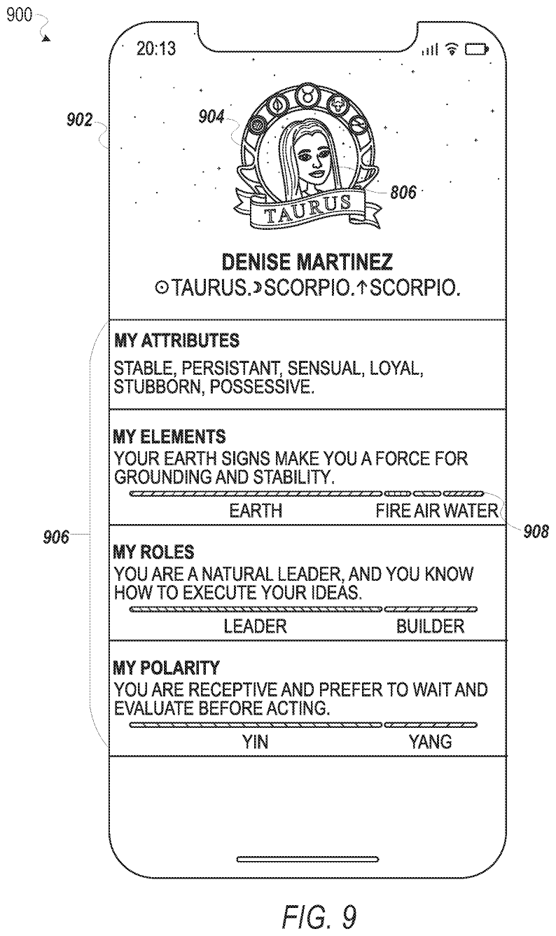

FIG. 9 is an interface diagram 900 depicting a GUI (i.e., an astrological interface 902) generated and displayed by an astrological interface system 124, according to certain example embodiments. As seen in FIG. 9, the astrological interface 902 comprises a display of media content 904, wherein the media content 904 is generated based on a user identifier associated with the user (i.e., a user identifier 806), and an astrological sign assigned to the user based on user attributes of the user (i.e., Taurus).

The astrological interface 902 also includes a display of an astrological profile 906, wherein the astrological profile 906 is generated based on user attributes of the user. The astrological profile 906 may comprise a display of a plurality of content categories (i.e., “my elements,” “my roles,” “my polarity”), wherein each content category comprises a visualization based on user attributes of the user, such as the visualization 908.

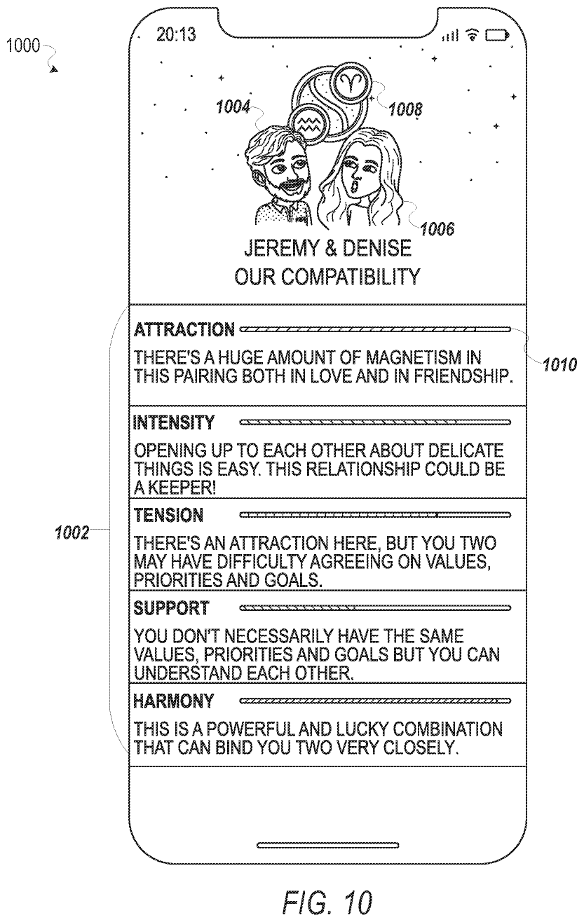

FIG. 10 is an interface diagram 1000 depicting a presentation of a compatibility index 1002 generated by an astrological interface system 124, according to certain example embodiments. As seen in FIG. 10, the compatibility index 1002 comprises a display of a plurality of compatibility categories (i.e., “attraction,” “intensity,” “tension,” “support,” “harmony”), wherein each compatibility category is scored based on astrological attributes of a first user and astrological attributes of a second user, as discussed in the method 400 depicted in FIG. 4.

For example, a first user may be assigned a first astrological sign with corresponding astrological attributes based on user attributes of the first user. A second user is assigned a second astrological sign with corresponding astrological attributes based on user attributes of the second user. The astrological interface system 124 accesses the corresponding astrological attributes of the first and second user and generates scores for each of the compatibility categories as depicted in the compatibility index 1002. Accordingly, the astrological interface system 124 causes display of a visual indicator of the scores in each of the compatibility categories in the compatibility index 1002.

As seen in FIG. 10, the compatibility index 1002 comprises a plurality of score indicators (i.e., score indicator 1010), wherein the score indicators may comprise a score bar that depicts the score as a portion of the score bar. As seen in the score indicator 1010, the score of the “attraction” category is depicted as a highlighted portion of a score bar.

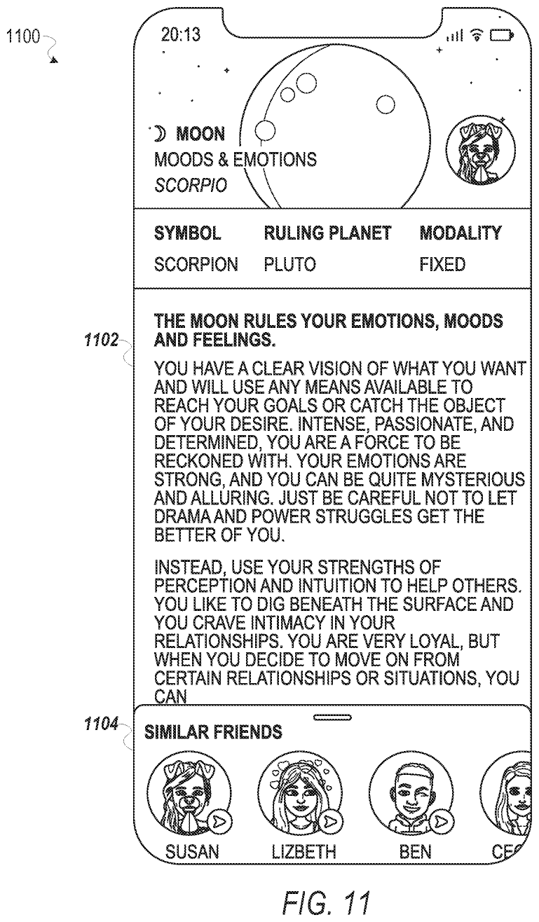

FIG. 11 is an interface diagram 1100 depicting a GUI 1102 generated and displayed by an astrological interface system 124, according to certain example embodiments. As seen in FIG. 11, the GUI 1102 may include a display of a notification window 1104 to present one or more user identifiers of users identified based on the astrological attributes of a user.

For example, the notification window 1104 may comprise a display of user identifier associated with users that match with the user based on their own corresponding astrological attributes. The astrological interface system 124 may generate compatibility indexes for a plurality of users from a list of user connections of a user or based on geolocation criteria. The astrological interface system 124 may then present user identifiers of a portion of those users from the plurality of users based on a determination that the scores from the corresponding compatibility indices transgresses a threshold value.

Software Architecture

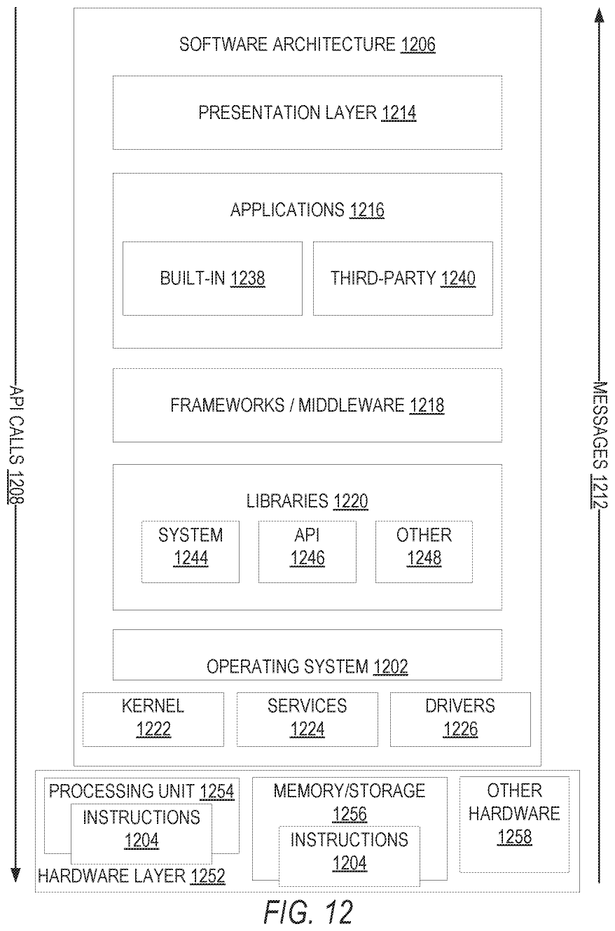

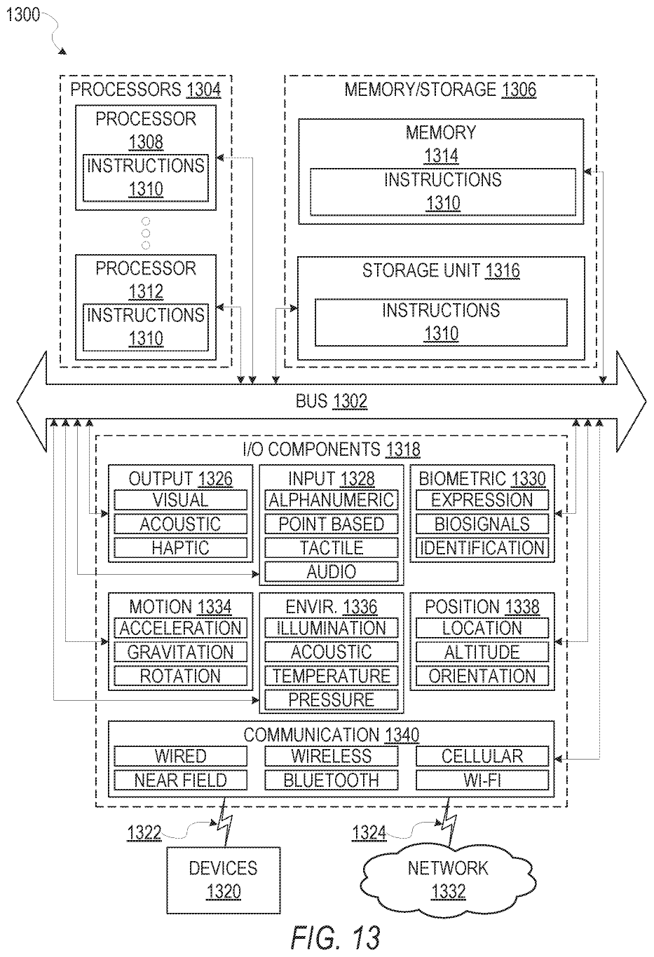

FIG. 12 is a block diagram illustrating an example software architecture 1206, which may be used in conjunction with various hardware architectures herein described. FIG. 12 is a non-limiting example of a software architecture and it will be appreciated that many other architectures may be implemented to facilitate the functionality described herein. The software architecture 1206 may execute on hardware such as machine 1300 of FIG. 13 that includes, among other things, processors 1304, memory 1314, and I/O components 1318. A representative hardware layer 1252 is illustrated and can represent, for example, the machine 1200 of FIG. 12. The representative hardware layer 1252 includes a processing unit 1254 having associated executable instructions 1204. Executable instructions 1204 represent the executable instructions of the software architecture 1206, including implementation of the methods, components and so forth described herein. The hardware layer 1252 also includes memory and/or storage modules memory/storage 1256, which also have executable instructions 1204. The hardware layer 1252 may also comprise other hardware 1258.

In the example architecture of FIG. 12, the software architecture 1206 may be conceptualized as a stack of layers where each layer provides particular functionality. For example, the software architecture 1206 may include layers such as an operating system 1202, libraries 1220, applications 1216 and a presentation layer 1214. Operationally, the applications 1216 and/or other components within the layers may invoke application programming interface (API) API calls 1208 through the software stack and receive a response as in response to the API calls 1208. The layers illustrated are representative in nature and not all software architectures have all layers. For example, some mobile or special purpose operating systems may not provide a frameworks/middleware 1218, while others may provide such a layer. Other software architectures may include additional or different layers.

The operating system 1202 may manage hardware resources and provide common services. The operating system 1202 may include, for example, a kernel 1222, services 1224 and drivers 1226. The kernel 1222 may act as an abstraction layer between the hardware and the other software layers. For example, the kernel 1222 may be responsible for memory management, processor management (e.g., scheduling), component management, networking, security settings, and so on. The services 1224 may provide other common services for the other software layers. The drivers 1226 are responsible for controlling or interfacing with the underlying hardware. For instance, the drivers 1226 include display drivers, camera drivers. Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1220 provide a common infrastructure that is used by the applications 1216 and/or other components and/or layers. The libraries 1220 provide functionality that allows other software components to perform tasks in an easier fashion than to interface directly with the underlying operating system 1202 functionality (e.g., kernel 1222, services 1224 and/or drivers 1226). The libraries 1220 may include system libraries 1244 (e.g., C standard library) that may provide functions such as memory allocation functions, string manipulation functions, mathematical functions, and the like. In addition, the libraries 1220 may include API libraries 1246 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1220 may also include a wide variety of other libraries 1248 to provide many other APIs to the applications 1216 and other software components/modules.

The frameworks/middleware 1218 (also sometimes referred to as middleware) provide a higher-level common infrastructure that may be used by the applications 1216 and/or other software components/modules. For example, the frameworks/middleware 1218 may provide various graphic user interface (GUI) functions, high-level resource management, high-level location services, and so forth. The frameworks/middleware 1218 may provide a broad spectrum of other APIs that may be utilized by the applications 1216 and/or other software components/modules, some of which may be specific to a particular operating system 1202 or platform.

The applications 1216 include built-in applications 1238 and/or third-party applications 1240. Examples of representative built-in applications 1238 may include, but are not limited to, a contacts application, a browser application, a book reader application, a location application, a media application, a messaging application, and/or a game application. Third-party applications 1240 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1240 may invoke the API calls 1208 provided by the mobile operating system (such as operating system 1202) to facilitate functionality described herein.

The applications 1216 may use built in operating system functions (e.g., kernel 1222, services 1224 and/or drivers 1226), libraries 1220, and frameworks/middleware 1218 to create user interfaces to interact with users of the system. Alternatively, or additionally, in some systems interactions with a user may occur through a presentation layer, such as presentation layer 1214. In these systems, the application/component “logic” can be separated from the aspects of the application/component that interact with a user.

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1310 (e.g., software, a program, an application, an applet, an app, or other executable code) for causing the machine 1300 to perform any one or more of the methodologies discussed herein may be executed. As such, the instructions 1310 may be used to implement modules or components described herein. The instructions 1310 transform the general, non-programmed machine 1300 into a particular machine 1300 programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1310, sequentially or otherwise, that specify actions to be taken by machine 1300. Further, while only a single machine 1300 is illustrated, the term “machine” shall also be taken to include a collection of machines that individually or jointly execute the instructions 1310 to perform any one or more of the methodologies discussed herein.

The machine 1300 may include processors 1304, memory memory/storage 1306, and I/O components 1318, which may be configured to communicate with each other such as via a bus 1302. The memory/storage 1306 may include a memory 1314, such as a main memory, or other memory storage, and a storage unit 1316, both accessible to the processors 1304 such as via the bus 1302. The storage unit 1316 and memory 1314 store the instructions 1310 embodying any one or more of the methodologies or functions described herein. The instructions 1310 may also reside, completely or partially, within the memory 1314, within the storage unit 1316, within at least one of the processors 1304 (e.g., within the processor's cache memory), or any suitable combination thereof, during execution thereof by the machine 1300. Accordingly, the memory 1314, the storage unit 1316, and the memory of processors 1304 are examples of machine-readable media.

The I/O components 1318 may include a wide variety of components to receive input, provide output, produce output, transmit information, exchange information, capture measurements, and so on. The specific I/O components 1318 that are included in a particular machine 1300 will depend on the type of machine. For example, portable machines such as mobile phones will likely include a touch input device or other such input mechanisms, while a headless server machine will likely not include such a touch input device. It will be appreciated that the I/O components 1318 may include many other components that are not shown in FIG. 13. The I/O components 1318 are grouped according to functionality merely for simplifying the following discussion and the grouping is in no way limiting. In various example embodiments, the I/O components 1318 may include output components 1326 and input components 1328. The output components 1326 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1328 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1318 may include biometric components 1330, motion components 1334, environmental environment components 1336, or position components 1338 among a wide array of other components. For example, the biometric components 1330 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1334 may include acceleration sensor components (e.g., accelerometer), gravitation sensor components, rotation sensor components (e.g., gyroscope), and so forth. The environment components 1336 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1338 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1318 may include communication components 1340 operable to couple the machine 1300 to a network 1332 or devices 1320 via coupling 1322 and coupling 1324 respectively. For example, the communication components 1340 may include a network interface component or other suitable device to interface with the network 1332. In further examples, communication components 1340 may include wired communication components, wireless communication components, cellular communication components, Near Field Communication (NFC) components, Bluetooth® components (e.g., Bluetooth® Low Energy). Wi-Fi® components, and other communication components to provide communication via other modalities. The devices 1320 may be another machine or any of a wide variety of peripheral devices (e.g., a peripheral device coupled via a Universal Serial Bus (USB)).

Moreover, the communication components 1340 may detect identifiers or include components operable to detect identifiers. For example, the communication components 1340 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1340, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions.

Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”. “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“LIFT” in this context is a measure of the performance of a targeted model at predicting or classifying cases as having an enhanced response (with respect to a population as a whole), measured against a random choice targeting model.

“PHONEME ALIGNMENT” in this context, a phoneme is a unit of speech that differentiates one word from another. One phoneme may consist of a sequence of closure, burst, and aspiration events; or, a dipthong may transition from a back vowel to a front vowel. A speech signal may therefore be described not only by what phonemes it contains, but also the locations of the phonemes. Phoneme alignment may therefore be described as a “time-alignment” of phonemes in a waveform, in order to determine an appropriate sequence and location of each phoneme in a speech signal.

“AUDIO-TO-VISUAL CONVERSION” in this context refers to the conversion of audible speech signals into visible speech, wherein the visible speech may include a mouth shape representative of the audible speech signal.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLS™)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

What is claimed is:

1. A method comprising:
accessing first user profile data of a first user, the first user profile data including a birthdate;
assigning a first astrological sign from among a plurality of astrological signs to the first user based on the birthdate, the first astrological sign corresponding with a first set of attributes;
accessing second user profile data of a second user, the second user profile associated with a second astrological sign from among the plurality of astrological signs, the second astrological sign corresponding with a second set of attributes;
generating a compatibility index based on the first set of attributes and the second set of attributes, the compatibility index comprising a plurality of compatibility categories that include corresponding scores;
generating a visualization of the compatibility index, the visualization of the compatibility index based on the first astrological sign and the second astrological sign; and
causing display of a presentation of the visualization at a client device.

2. The method of claim 1, wherein the accessing the second user profile data of the second user includes:
accessing a list of user connections associated with the first user, the list of user connections including at least the second user; and
identifying the second user from among the list of user connections based on at least the second set of attributes associated with the second astrological sign.

3. The method of claim 1, wherein the causing display of the visualization at the client device includes:
determining one or more scores of the plurality of compatibility categories transgresses a threshold value; and
causing display of the presentation of the visualization at the client device in response to determining that the one or more scores of the plurality of compatibility categories transgresses the threshold value.

4. The method of claim 1, wherein the client device is a client device associated with the second user, and the causing display of the presentation of the visualization at the client device includes:
generating a message that includes the presentation of the visualization; and
causing display of a notification that includes the message at the client device.

5. The method of claim 1, wherein the generating the visualization of the compatibility index includes:
accessing a media repository that comprises a media collection associated with the first astrological sign and the second astrological sign;
generating media content based on the media collection, the first set of attributes associated with the first astrological sign, and the second set of attributes associated with the second astrological sign; and
generating the presentation of the visualization based on the media content.

6. The method of claim 1, wherein the visualization of the compatibility index comprises a display of a plurality of score indicators, each score indicator among the plurality of score indicators depicting a score of a compatibility category from among the plurality of compatibility categories.

7. The method of claim 6, wherein the score indicator comprises a score bar that depicts the score as a portion of the score bar.

8. A system comprising:
a memory; and
at least one hardware processor coupled to the memory and comprising instructions that causes the system to perform operations comprising: accessing first user profile data of a first user, the first user profile data including a birthdate;
assigning a first astrological sign from among a plurality of astrological signs to the first user based on the birthdate, the first astrological sign corresponding with a first set of attributes;
accessing second user profile data of a second user, the second user profile associated with a second astrological sign from among the plurality of astrological signs, the second astrological sign corresponding with a second set of attributes;
generating a compatibility index based on the first set of attributes and the second set of attributes, the compatibility index comprising a plurality of compatibility categories that include corresponding scores;
generating a visualization of the compatibility index, the visualization of the compatibility index based on the first astrological sign and the second astrological sign; and
causing display of a presentation of the visualization at a client device.

9. The system of claim 8, wherein the accessing the second user profile data of the second user includes:
accessing a list of user connections associated with the first user, the list of user connections including at least the second user; and
identifying the second user from among the list of user connections based on at least the second set of attributes associated with the second astrological sign.

10. The system of claim 8, wherein the causing display of the visualization at the client device includes:
determining one or more scores of the plurality of compatibility categories transgresses a threshold value; and
causing display of the presentation of the visualization at the client device in response to determining that the one or more scores of the plurality of compatibility categories transgresses the threshold value.

11. The system of claim 8, wherein the client device is a client device associated with the second user, and the causing display of the presentation of the visualization at the client device includes:
generating a message that includes the presentation of the visualization; and
causing display of a notification that includes the message at the client device.

12. The system of claim 8, wherein the generating the visualization of the compatibility index includes:
accessing a media repository that comprises a media collection associated with the first astrological sign and the second astrological sign;
generating media content based on the media collection, the first set of attributes associated with the first astrological sign, and the second set of attributes associated with the second astrological sign; and
generating the presentation of the visualization based on the media content.

13. The system of claim 8, wherein the visualization of the compatibility index comprises a display of a plurality of score indicators, each score indicator among the plurality of score indicators depicting a score of a compatibility category from among the plurality of compatibility categories.

14. The system of claim 13, wherein the score indicator comprises a score bar that depicts the score as a portion of the score bar.

15. A non-transitory machine-readable storage medium comprising instructions that, when executed by one or more processors of a machine, cause the machine to perform operations comprising:
accessing first user profile data of a first user, the first user profile data including a birthdate;
assigning a first astrological sign from among a plurality of astrological signs to the first user based on the birthdate, the first astrological sign corresponding with a first set of attributes;
accessing second user profile data of a second user, the second user profile associated with a second astrological sign from among the plurality of astrological signs, the second astrological sign corresponding with a second set of attributes;
generating a compatibility index based on the first set of attributes and the second set of attributes, the compatibility index comprising a plurality of compatibility categories that include corresponding scores;
generating a visualization of the compatibility index, the visualization of the compatibility index based on the first astrological sign and the second astrological sign; and
causing display of a presentation of the visualization at a client device.

16. The non-transitory machine-readable storage medium of claim 15, wherein the accessing the second user profile data of the second user includes:
accessing a list of user connections associated with the first user, the list of user connections including at least the second user; and
identifying the second user from among the list of user connections based on at least the second set of attributes associated with the second astrological sign.

17. The non-transitory machine-readable storage medium of claim 15, wherein the causing display of the visualization at the client device includes:
determining one or more scores of the plurality of compatibility categories transgresses a threshold value; and
causing display of the presentation of the visualization at the client device in response to determining that the one or more scores of the plurality of compatibility categories transgresses the threshold value.

18. The non-transitory machine-readable storage medium of claim 15, wherein the client device is a client device associated with the second user, and the causing display of the presentation of the visualization at the client device includes:
generating a message that includes the presentation of the visualization; and
causing display of a notification that includes the message at the client device.

19. The non-transitory machine-readable storage medium of claim 15, wherein the generating the visualization of the compatibility index includes:
accessing a media repository that comprises a media collection associated with the first astrological sign and the second astrological sign;
generating media content based on the media collection, the first set of attributes associated with the first astrological sign, and the second set of attributes associated with the second astrological sign; and
generating the presentation of the visualization based on the media content.

20. The non-transitory machine-readable storage medium of claim 15, wherein the visualization of the compatibility index comprises a display of a plurality of score indicators, each score indicator among the plurality of score indicators depicting a score of a compatibility category from among the plurality of compatibility categories.
